(19) United States
(12) Patent Application Publication
(10) Pub. No.: US 2011/0174239 A1
(43) Pub. Date: Jul. 21, 2011

(54) Locking Mechanism for a Safety Collar for a Domestic Animal

(75) Inventors: Hanns Fricker, Meggen (CH); Jaime Rossell, Pully (CH)

(73) Assignee: STMZ SCHWEIZERISCHE TIERMELDEZENTRALE AG, HERGISWIL (CH)

(21) Appl. No.: 12/993,971

(22) PCT Filed: May 22, 2009
(86) PCT No.: PCT/CH2009/000171

§ 371 Date: Dec. 23, 2010

(30) Foreign Application Priority Data
May 21, 2008 (CH) 764/08

(51) Int. Cl. A01K 27/00; A44B 11/25

(52) U.S. Cl. 119/865; 24/580.1

(57) ABSTRACT

The invention relates to a locking mechanism for a safety collar, which comprises a first end part (11, 21, 31, 1001) with a first latch (12, 22, 32, 1002) and a second latch (13, 23, 33, 1003) and a second end part (15, 25, 35, 1005) with a central latch (16, 26, 36, 1006). The end parts can be connected. The locking mechanism is characterized in that the first latch (12, 22, 32, 1002) has a first opening (17, 27), the second latch (13, 23, 1003) has a second opening (18, 28) and the middle latch (16, 26, 36, 1006) has a central opening (110, 210) and that the locking mechanism comprises a set screw (41, 1007), which passes through the first opening (17, 27), the central opening (110, 210) and the second opening (18, 28) and can be screwed into a mating thread (181), formed in the second opening, or bolted together with a lock nut (42, 1008) in such a manner, that the set screw (41, 1007), when bolted together with the lock nut (42, 1008) or screwed into the mating thread (181), is able to press together the first latch (12, 22, 32, 1002) and the second latch (13, 23, 33, 1003).

The present invention relates to a locking mechanism for a safety collar for a pet, in particular for a cat, and to the safety collar having this locking mechanism.

In order to be able to identify stray pets, pets wear a tag attached to a collar, said tag bearing an identifiable code or the name of the pet. However, some pet owners, in particular cat owners, are reluctant to fit their pets with such a collar, because there is the risk that the collar could get caught somewhere, for example on a branch, and the pet, as it attempts to free itself, could suffer from strangulation injuries, which can have a fatal outcome in extreme cases. For this reason, special collars having a safety locking mechanism were developed for the wearing of tags. The safety locking mechanism can open under the effect of a tensile force greater than a fixed limit value that is dependent upon the design of the locking mechanism. If the pet wearing such a safety collar is snagged and attempts to free itself, this limit value for the tensile force is exceeded and the collar opens so that the pet does not strangle itself. For safety collars of this type, reference is made, by way of example, to U.S. Pat. No. 5,443,039 A.

U.S. Pat. No. 4,044,725 A describes a safety collar consisting of links, in which the links are fastened together by means of ball joints. For this purpose, each link has a ball head at one end and a matching ball socket at its other end. One of the links has at one end a ball head, which is split in the middle, and a screw, which can be screwed from the ball socket at the other end of the link into the split ball head. The halves of the split ball head can be flexibly spread apart by the screwing in of the screw. The ball joint which is formed by this split ball head and the ball socket of the adjacent link can thus be separated when a certain tensile force, which can be set, is exceeded. This tensile force is all the smaller, the less the ball halves are spread apart, i.e. the less the screw is screwed into the split ball head.

The object of the present invention is to create an improved locking mechanism for a safety collar for pets of the type mentioned at the beginning, in particular to a safety collar for cats.

This object is achieved according to the invention by a locking mechanism, comprising:

a) a first end part having a first tongue and a second tongue defining a tongue intermediate space lying between them; and
b) a second end part having a central tongue that can be inserted in a locking direction into the tongue intermediate space of the first end part,
characterized in that
c) the first tongue has a first opening, the second tongue has a second opening and the central tongue has a central opening, wherein these openings pass through the tongues and either have the form of a round hole or have the form of a groove which extends in the locking direction and is open toward the tongue tip, wherein these openings are aligned in the pushed-together state of the locking mechanism and wherein either at least the central opening is in the form of a groove or at least the first and second openings are in the form of grooves; and in that
d) the locking mechanism comprises an adjusting screw, which passes through the first opening, the central opening and the second opening and which, when the second opening is in the form of a groove, can be screwed together with a mating nut or, when the second opening is in the form of a round hole, can be screwed together either with a counterthread formed in this opening or with a mating nut, such that the adjusting screw, when it is screwed together with the mating nut or the counterthread, is able to squeeze the first and second tongues together.

Preferred embodiments of the locking mechanism according to the invention are given in the dependent patent claims. The subject of the invention is also a safety collar which has the locking mechanism according to the invention.

The adjusting screw allows to squeeze the first and second tongues together in an adjustably tight manner, as a result of which the minimum tensile force required to pull the central tongue out of the tongue intermediate space in the closed state can be set in a variable manner. For this purpose, the tongue intermediate space preferably has a form complementary to the central tongue.

The adjusting screw is suitable in the case of the locking mechanism according to the invention, on the one hand, and in contrast to the locking mechanisms of the prior art, for variably setting the minimum tensile force required to open the locking mechanism. On the other hand, since it passes through the three openings in the first, second and central tongues, it serves at the same time to guide the two end parts transversely during the opening or closing of the locking mechanism, and so the latter can be produced without additional lateral straps or tongues for transversal guidance.

The adjusting screw can, on the one hand, be a conventional screw having a thread extending over its entire shank. In order to avoid a damaging of the three openings by the thread, the adjusting screw is in this case preferably guided in a preferably metallic round sleeve. The round sleeve can be fitted loosely into the openings; if, however, a mating nut is present, the round sleeve is preferably formed in one piece with the mating nut. The round sleeve, if present, is freely movable with respect to the central tongue and the first tongue. The adjusting screw runs inside this sleeve such that its thread cannot damage these grooves and openings. In another preferred embodiment the adjusting screw has only a partial thread, in particular such that all those parts of the adjusting screw which must be freely movable with respect to the first and central openings are threadless. In this embodiment of the adjusting screw, the protective round sleeve can, under certain circumstances, also be dispensed with.

According to the invention, it is preferred that the head of the adjusting screw does not act directly on the first tongue, but rather that a resilient and/or elastic element, for example an annular spring or an annular core made of an elastomeric material (for example of rubber), is provided, which is present between the head of the adjusting screw and the first tongue, preferably also with use of one or two washers. This resilient and/or elastic element generates a counterforce, which counteracts the squeezing pressure of the head of the adjusting screw on the first tongue in a resilient and/or elastic manner, and allows a finer adjustment of the squeezing pressure of the adjusting screw on the first tongue.

The end parts and the tongues attached to them can in each case preferably be produced in one piece. The end parts preferably consist of a customary plastic. The central tongue can preferably be rigid; the first and second tongues can be rigid or flexible (see below).

The three openings are either in the form of a round hole or in the form of a groove, wherein either at least the two openings in the first end part or at least the one opening in the second end part are in the form of grooves, as described above. These two alternatives allow the two end parts to be opened or closed without the adjusting screw having to be entirely screwed out beforehand. All three openings could also be in the form of grooves. In a preferred embodiment, only the central opening is in the form of a groove and the first and second openings are in the form of round holes; in another preferred embodiment, only the first and second openings are in the form of grooves and the third opening is in the form of a round hole.

In a first preferred embodiment, the first, second and third tongues are provided with an irregular profile as seen in cross section, for instance such that the central tongue has convexities or catches which fit into corresponding complementary recesses on the insides of the first and second tongues (or vice versa). In this embodiment, the central tongue engages when introduced into the tongue intermediate space formed by the first and second tongues, and so such a locking mechanism works in accordance with the form-fitting principle, in particular somewhat like a snap-in lock. This embodiment of the locking mechanism requires first and second tongues made of a flexible material, for instance a flexible plastic, since in this case opening is only possible when the first and second tongues have been separated by yielding movements perpendicularly to the locking direction far enough from one another that said unevennesses of the profile in the form of convexities or catches can leave the complementary recesses. The adjusting screw in this case brings about setting of the spacing between the first and second tongues and thus influences the ease with which the first and second tongues can perform yielding movements perpendicularly to the locking direction. For these embodiments, it is particularly preferred that the head of the adjusting screw does not act directly on the first tongue, but rather that between them is provided said resilient and/or elastic element, in particular an annular spring or an annular core made of an elastomeric material (for instance of rubber), being positioned between the head of the adjusting screw and the first tongue, preferably with use of a washer. The resilient and/or elastic element in this case allows not only a finer adjustment of the squeezing pressure of the adjusting screw, but also enables said yielding movements perpendicularly to the closure direction of the first and second tongues, despite the virtually rigid force which the pair consisting of adjusting screw and mating nut (or counterthread) alone would exert on the first and second tongues. In order to enable any movements of the first, second and central tongues perpendicularly to the closure direction, it is also preferred that a very slight clearance is present between the adjusting screw (or the round sleeve, in which the adjusting screw extends) and the first and central openings.

In a second preferred embodiment of the locking mechanism the inner faces of the first and second tongues and the outer faces of the central tongue are planar (preferably plane-parallel). In these embodiments, the two end parts are inserted into each other like a pair consisting of plug and socket. Since in this case no unevennesses of the surfaces have to slide past one another during the closing or opening of the locking mechanism, substantially no simultaneous yielding movements of the first and second tongues perpendicularly to the closure direction are necessary. Therefore, in this case, the first and second tongues, as well as all of both end parts, can be formed not only from a plastic, but also from a substantially rigid material, for instance a metal. The locking mechanism opens here when the tensile forces which act on the two end parts exceed the static frictional force between the inner faces of the first and second tongues and the outer faces of the central tongue. These embodiments of the locking mechanism thus work in accordance with the force-fitting principle. The setting of the adjusting screw in this case sets the pressure with which the first and second tongues adhere to the central tongue in the closed state of the locking mechanism and thus determines said static frictional force. Here, too, a resilient and/or elastic element and, optionally, a washer as described above can be provided between the head of the adjusting screw, thereby enabling finer adjustment of the squeezing pressure.

Advantageously, a minimum tensile force for opening the locking mechanism is set by means of the adjusting screw, said minimum tensile force not being greater than or approximately equal to the weight force of the pet that is to wear a safety collar having this locking mechanism. Advantageously, this minimum tensile force is in the range from 20 N to 200 N, preferably in the range from 40 N to 140 N, more preferably in the range from 50 N to 100 N. In contrast to the locking mechanisms of the prior art, the locking mechanisms according to the invention can thus take into account the different weights and strengths of pets: small pets are more at risk of strangulation and therefore require a lower minimum tensile force to be set, whereas larger pets are stronger and require a higher minimum tensile force to be set. To set this minimum tensile force correctly, a scale can be attached to the head of the adjusting screw, stating, for a few exemplary positions of the adjusting screw, the minimum tensile force corresponding to these positions for opening the locking mechanism. The values for this scale can be determined by pulling trials on the locking mechanism with known weights.

In a generally preferred embodiment, the first end part or the second end part can comprise a chip containing a stored code, which can be read out contactlessly with a corresponding reader, thereby identifying the pet. On the basis of the code which can be determined in this way, the owner of the animal can be traced by means of a database and the animal can be returned to the owner. Such a chip is known as an RFID chip (for “Radio Frequency Identification”). By employing such a chip, it is no longer necessary to attach a conventional tag to the safety collar comprising such a locking mechanism according to the invention; moreover, the pet does not need to have the RFID chip implanted, as has usually been the case hitherto with such chips. It has been shown that an RFID chip incorporated into a locking mechanism according to the invention can be read more easily with the usual readers than when it is implanted in the animal.

Apart from the locking mechanism, the safety collar according to the invention can be conventional. It can be produced for instance as a leather strip, a plastic strip or from plastic links. In order to fit the collar on the two end parts, the latter have, usually at the ends opposite to the tongues, receiving openings passing through them. The ends of the collar could, however, also be secured in a different way, for instance by riveting or by gluing into transverse slits, which are provided at the ends of the end parts opposite to the tongues. In order to use it as a safety locking mechanism for a pet collar, it is advantageous if the locking mechanism as a whole has a slightly curved form, which has approximately the same curvature as the rest of the collar when it is put around the neck of the pet.

The locking mechanism according to the invention is described in more detail in the following text, with reference to the appended drawings, in which:

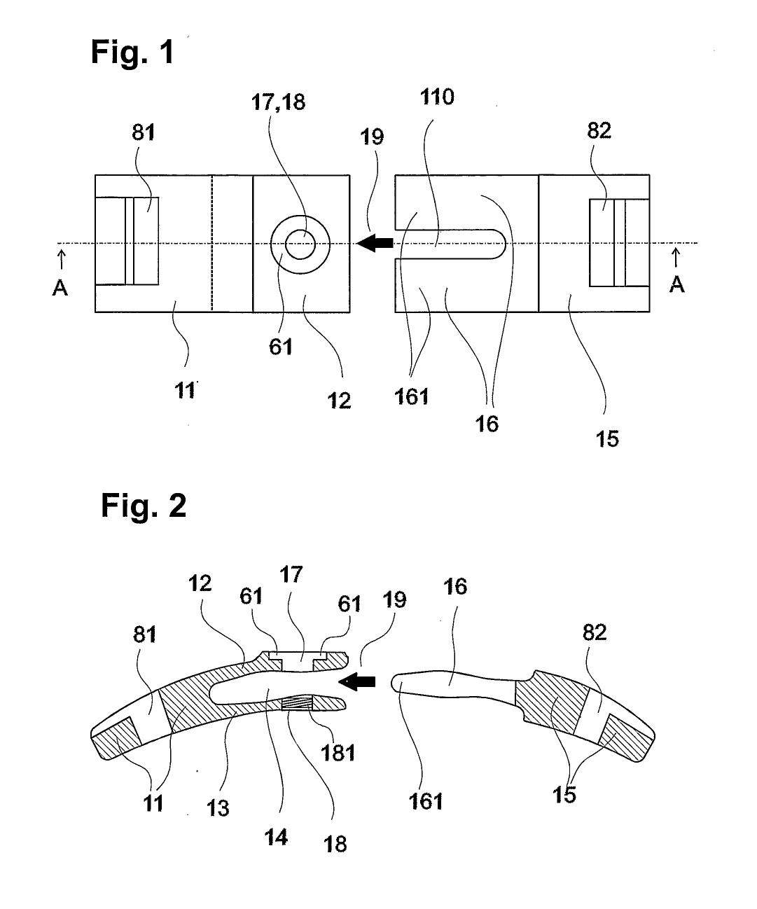

FIG. 1—shows a top view of the first and second end parts of a locking mechanism according to the invention, in which the first and second openings are in the form of round holes and the central opening is in the form of a groove.

FIG. 2—shows a sectional representation of the first and second end parts of FIG. 1, wherein the section extends along the line A-A in FIG. 1.

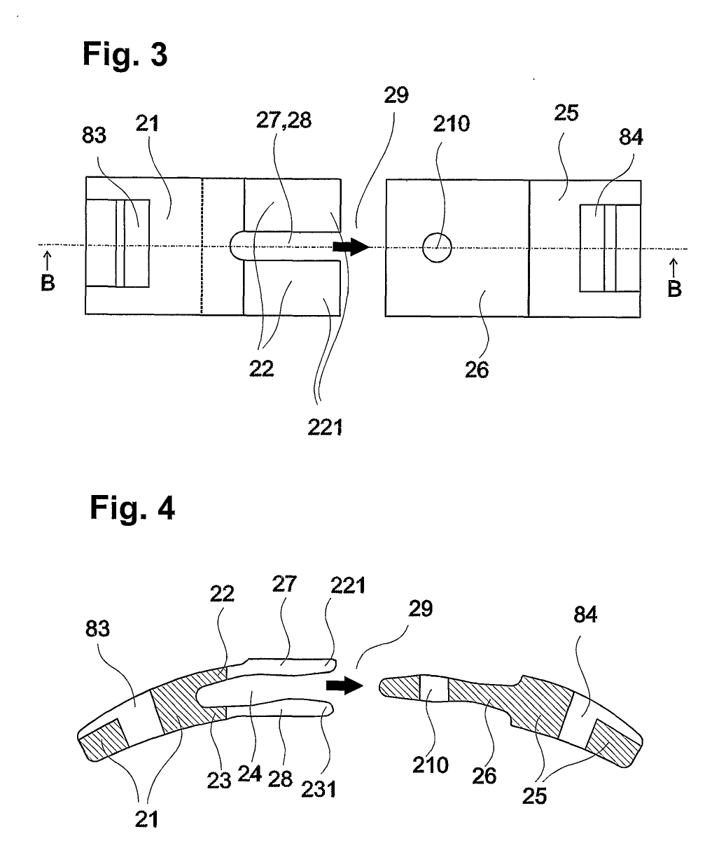

FIG. 3—shows a top view of the first and second end parts of a locking mechanism according to the invention, in which the first and second openings are in the form of grooves and the central opening is in the form of a round hole.

FIG. 4—shows a sectional representation of the first and second end parts of FIG. 3, wherein the section extends along the line B-B in FIG. 3.

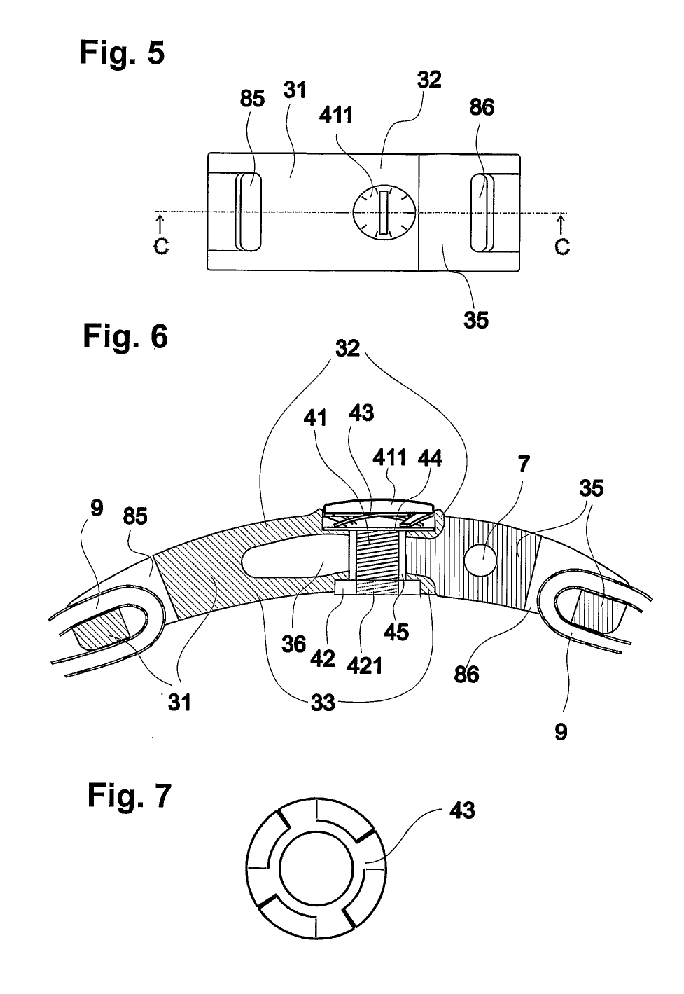

FIG. 5—shows a top view of an entire locking mechanism according to the invention, in which the first and second end parts are similar to those in FIGS. 1 and 2.

FIG. 6—shows a partial sectional drawing of the locking mechanism of FIG. 5 with an annular spring as the resilient element, wherein the section through FIG. 5 extends along the line C-C.

FIG. 7—shows a top view of the annular spring, which is shown from the side in FIG. 6.

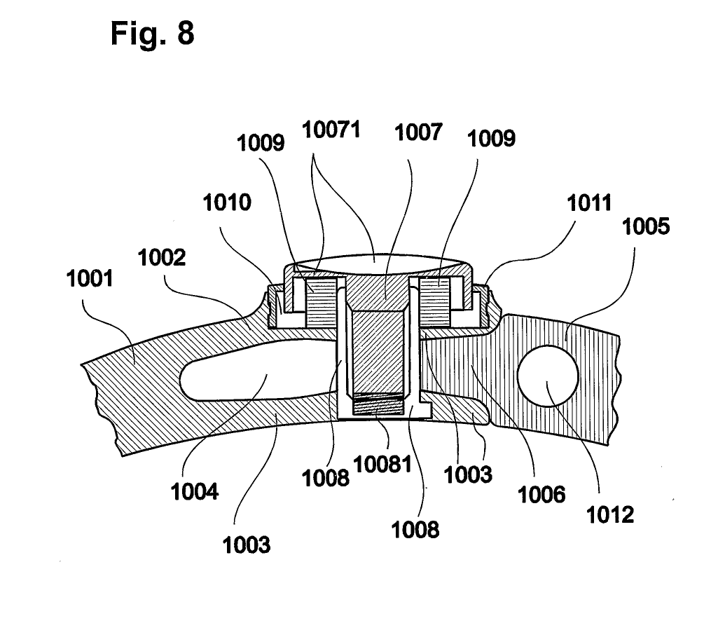

FIG. 8—shows a partial sectional drawing of a locking mechanism similar to that of FIG. 6, but with an annular core made of an elastomeric material as the resilient and/or elastic element.

In the first embodiment of first and second end parts 11, 15, illustrated in FIGS. 1 and 2, the first opening 17 and the second opening 18 are both in the form of round holes and the two openings are aligned, i.e. they lie one on top of the other in the top view. For this reason both reference numerals 17 and 18 are given for the one opening shown in FIG. 1. The first opening 17 is formed in a first tongue 12 and the second opening 18 in a second tongue 13. The second end part 15 has a central tongue 16 having a central opening 110 in the form of a groove, which extends in the locking direction 19 and is open toward the tip of the central tongue 16 (i.e. toward the tongue tip 161). When the central tongue 16 of the second end part 15 is pushed in the locking direction 19 into the tongue intermediate space 14, the central opening 110 comes to rest in the top view precisely below the first opening 17 and atop of the second opening 18, and so all three openings 17, 110 and 18 are aligned. This enables the adjusting screw (not shown in FIGS. 1 and 2) to pass through all three openings. In this embodiment, where the second opening 18 is in the form of a round hole, the adjusting screw can cooperate with a thread 181 formed in the second opening 18. As an alternative to this thread 181, it would also be possible to leave the second opening 18 without a thread and instead to provide an additional, separate mating nut (not shown in FIGS. 1 and 2), which would cooperate with the adjusting screw. The first opening 17, which is likewise in the form of a round hole, has an annular recess 61, which serves for the at least partial countersinking of the head of the adjusting screw and of an optional resilient and/or elastic element, for instance an annular spring or an annular core made of an elastomeric material and an optional washer. In accordance with the preferred purpose of the locking mechanism according to the invention, the first end part 11 and the second end part 15 in this case each have a receiving opening 81 and 82, respectively, around which the ends of the safety collar can be looped.

In the second embodiment of the first and second end parts 21, 25, shown in FIGS. 3 and 4, the first opening 27 is formed in a first tongue 22 and the second opening 28 in a second tongue 23. Here both first opening 27 and second opening 28 are in the form of grooves, extend in the locking direction 29 and are open toward the tips of the first and second tongues 22, 23 (i.e. toward the tongue tips 221, 231). First and second openings 27, 28 are aligned, i.e. they lie precisely one atop of the other in the top view, and for this reason the two reference numerals 27 and 28 are given for the one opening shown in FIG. 3. The second end part 25 has a central tongue 26 having a central opening 210 in the form of a round hole. When first and second tongues 22, 23 of the first end part 21 are pushed in the locking direction 29 over the central tongue 26 of the second end part 25, the central opening 210 comes to rest in the top view precisely below the first opening 27 and atop of the second opening 28, so that all three openings 27, 210 and 28 are aligned. This enables the passing through of the adjusting screw (not shown in the figures). In this embodiment, where the first and second openings 27, 28 are in the form of grooves, the adjusting screw would cooperate with an additional, separate mating nut (likewise not shown in the figure), which would be underneath the second tongue 23. Preferably, washers would be provided here, both between the head of the adjusting screw and the first tongue and between the mating nut and the second tongue. In accordance with the purpose of the locking mechanism according to the invention, the first end part 21 and the second end part 25 in turn each have a receiving opening 83 and 84, around which the ends of the safety collar can be looped.

The exemplary embodiment, shown in FIGS. 5 and 6, of a complete locking mechanism according to the invention has two end parts 31, 35, which have a design similar to the one in FIGS. 1 and 2. Here is only shown the adjusting screw 41, which cooperates with a mating nut 42. The threads of adjusting screw 41 and mating nut 42 are indicated; the thread of the mating nut 42 is provided with the reference numeral 421. The mating nut 42 is countersunk into the second tongue 33. The central tongue 36 is for the most part not shown here in section (i.e. not hatched), since the section line C-C extends precisely through the opening in the form of a groove of the central tongue 36. In order for the thread of the adjusting screw 41 not to damage the openings in the first, second and central tongues 32, 33, 36, the adjusting screw 41 runs in a metallic round sleeve 45, which can either be loose or, preferably, is in one piece with the mating nut 42. Accordingly, the adjusting screw 41 is illustrated here with a full thread. In this embodiment, the head 411 of the adjusting screw 41 does not act directly on the first tongue 32, but a round spring 43 and a washer 44 are instead provided in between them. In accordance with the primary purpose of the locking mechanism as a safety collar for pets, the second end part 35 here has an incorporated RFID chip 7; the openings 85, 86 for the safety collar and also the outline of the safety collar 9 itself are again shown.

FIG. 7 shows the round spring 43, shown in side view in FIG. 6, once again in top view. This round spring has four resilient lamellae, which point downward from the plane of the page and represent a right-hand screw in the present case. This round spring can be produced for instance from a ring of spring steel, in that the resilient lamellae are punched and bent downward.

FIG. 8 shows part of an exemplary embodiment of a locking mechanism according to the invention in the pushed-together state. It has again two end parts 1001, 1005, which are formed similarly to the end parts in FIGS. 1 and 2; the receiving openings for the collar are, however, no longer shown here. The first end part 1001 has a first tongue 1002 and a second tongue 1003; between these there is formed a tongue intermediate space 1004. The second end part 1005 has a central tongue 1006. The adjusting screw 1007 having a head 10071 is shown, it can be screwed together with a mating nut having an integrally formed metallic round sleeve (not shown in section, i.e. not hatched, both together are provided with reference numeral 1008). The lenticular part of the head 10071, which is not shown in section, i.e. not hatched, indicates a slit formed therein, by means of which the adjusting screw 1007 could be adjusted with a screwdriver or with a fingernail in order to regulate the squeezing pressure. The threads of the adjusting screw 1007 and the mating nut/round sleeve 1008, which are screwed together, are provided with the reference numeral 10081. The first or second end part 1001, 1005 would each have a first or second opening, respectively, in the form of a round hole here, in order for the adjusting screw 1007 to pass through (these openings are not shown in the figure). The central tongue 1006 would here have an opening in the form of a groove. The central tongue 1006 is illustrated here for the most part not in section, i.e. not hatched, since the section line extends precisely through this opening in the form of a groove in the central tongue 1006 (the opening in the form of a groove thus lies spatially within the tongue intermediate space 1004). The head 10071 of the adjusting screw 1007 does not act directly on the first tongue 1002; provided in between is a resilient and/or elastic element in the form of an annular core 1009 made of rubber. The head of the adjusting screw 1007 is inserted into an annular recess 1010, wherein a metallic annular holder 1011 for the head 10071 is additionally provided. An RFID chip 1012 incorporated into the second end part 1005 is again indicated.

1. A locking mechanism, comprising:
a) a first end part (11, 21, 31, 1001) having a first tongue (12, 22, 32, 1002) and a second tongue (13, 23, 33, 1003), defining a tongue intermediate space (14, 24, 1004) lying between them; and
b) a second end part (15, 25, 35, 1005) having a central tongue (16, 26, 36, 1006) that can be inserted in a locking direction (19, 29) into the tongue intermediate space (14, 24, 1004) of the first end part (11, 21, 31, 1001),
in which
c) the first tongue (12, 22, 32, 1002) has a first opening (17, 27), the second tongue (13, 23, 1003) has a second opening (18, 28) and the central tongue (16, 26, 36, 1006) has a central opening (110, 210), wherein these openings pass through the tongues and either have the form of a round hole or have the form of a groove which extends in the locking direction (19, 29) and is open toward the tongue tip (161, 221, 231), wherein these openings are aligned in the pushed-together state of the locking mechanism and either at least the central opening (110) is in the form of a groove or at least the first (27) and second (28) openings are in the form of grooves;
and in which
d) the locking mechanism comprises an adjusting screw (41, 1007), which passes through the first opening (17, 27), the central opening (110, 210) and the second opening (18, 28) and which, when the second opening (28) is in the form of a groove, can be screwed together with a mating nut (42) or, when the second opening (18) is in the form of a round hole, can be screwed together either with a counterthread (181) formed in this opening or with a mating nut (42, 1008), such that the adjusting screw (41, 1007), when it is screwed together with the mating nut (42, 1008) or the counterthread (181), is able to squeeze the first (12, 22, 32, 1002) and second (13, 23, 33, 1003) tongues together.

2. The locking mechanism as claimed in claim 1, in which the first (17) and second (18) openings are in the form of round holes and the central opening (110) is in the form of a groove.

3. The locking mechanism as claimed in claim 2, in which the adjusting screw (41, 1007) can be screwed together with a mating nut (42, 1008).

4. The locking mechanism as claimed in claim 2, in which the first tongue (12, 1002) has an annular recess (61, 1010) for receiving the head (411, 10071) of the adjusting screw (41, 1007).

5. The locking mechanism as claimed in claim 1, in which the first (27) and second (28) openings are in the form of grooves and the central opening (210) is in the form of a round hole.

6. The locking mechanism as claimed in claim 1, in which the head (411, 10071) of the adjusting screw (41, 1007) rests on the first tongue (32, 1002) via a resilient and/or elastic element, in particular a round spring (43) or an annular core made of an elastomeric material (1009), and if desired via a washer (44).

7. The locking mechanism as claimed in claim 6, in which in the locked state of the locking mechanism the first end part (11, 21, 31, 1001) and the second end part (15, 25, 35, 1005) are connected together by means of a form fit between the first tongue (12, 22, 32, 1002), the central tongue (16, 26, 36, 1006) and the second tongue (13, 23, 33, 1003), in that the first tongue (12, 22, 32, 1002) and the second tongue (13, 23, 33, 1003) are flexible, and in that the adjusting screw (41, 1007) is able to set the distance between the first tongue (12, 22, 32, 1002) and the second tongue (13, 23, 33, 1003).

8. The locking mechanism as claimed in claim 1, in which, in the locked state of the locking mechanism, the first end part and the second end part are connected together by means of a force fit between the first tongue, the central tongue and the second tongue, and in that the adjusting screw is able to set the pressure with which the first tongue and the second tongue adhere to the central tongue.

9. The locking mechanism as claimed in claim 1, in which either the first end part (11, 21, 31, 1001) or the second end part (15, 25, 35, 1005) has an installed RFID chip (7, 1012).

10. A safety collar for a pet, in particular for a cat, comprising a locking mechanism as defined in claim 1.
